(19) United States
(12) Patent Application Publication
(10) Pub. No.: US 2012/0169899 A1
(43) Pub. Date: Jul. 5, 2012

(54) ELECTRONIC DEVICE AND METHOD FOR SEARCHING FOR OBJECT

(75) Inventors: Ridhi CHUGH, New Delhi (IN); Madhu SHANKAR K.S., Bangalore (IN)

(73) Assignee: SAMSUNG ELECTRONICS CO., LTD., Suwon-si (KR)

(21) Appl. No.: 13/341,140

(22) Filed: Dec. 30, 2011

(30) Foreign Application Priority Data
Dec. 30, 2010 (IN) 4030/CHE/2010
Oct. 21, 2011 (KR) 10-2011-0108182

(51) Int. Cl. H04N 5/76; H04N 5/228

(52) U.S. Cl. 348/231.4; 348/231.3; 348/222.1; 348/E05.024

(57) ABSTRACT

An electronic device and a method for searching for an object in a predetermined space are provided, the electronic device including: a storage unit which stores information regarding the object; a photographing unit which photographs at least one image of the predetermined space around the electronic device; and a control unit which controls to search the at least one image photographed by the photographing unit for the object for which information is stored in the storage unit, in and to store a search result in the storage unit.

### CROSS-REFERENCE TO RELATED APPLICATIONS

This application claims priority from Indian Patent Application No. 4030/CHE/2010, filed Dec. 30, 2010 in the Indian Intellectual Property Office, and from Korean Patent Application No. 10-2011-0108182, filed Oct. 21, 2011 in the Korean Intellectual Property Office, the disclosures of which are incorporated herein by reference in their entirety.

### BACKGROUND

1. Field

Methods and apparatuses consistent with exemplary embodiments herein relate to an electronic device and a method for searching for an object, and more particularly, to an electronic device which searches for an object around the electronic device using a camera, and a method for searching for an object around the electronic device.

2. Description of the Related Art

A receiver tag is usually attached to an object which needs to be tracked so that the object can be tracked by a transmitter as it transmits a signal to the receiver tag. In more detail, when a switch of a transmitter is turned on, a receiver tag emits light or produces a beep sound indicating the location of an object that a user wishes to track down.

However, a receiver tag has some serious drawbacks. For example, if a receiver tag is out of order, or if the operation time of a receiver tag exceeds a preset time limit, or if the receiver tag is far away from an object to be tracked, the receiver tag may not operate properly. In addition, if an object is in a corner which is not easy to access, a user may have difficulty in finding the object even through a beeping sound or a light.

Accordingly, there is a need to develop a system for resolving the above problems.

### SUMMARY

Exemplary embodiments address at least the above problems and/or disadvantages and other disadvantages not described above. However, an exemplary embodiment is not required to overcome the disadvantages described above, and an exemplary embodiment may not overcome any of the problems described above.

Exemplary embodiments relate to an electronic device for searching for an object around the electronic device and a method for searching for an object.

According to an aspect of an exemplary embodiment, there is provided electronic device for searching for an object around the electronic device, there is provided a storage unit which stores information regarding the object, a photographing unit which photographs a predetermined area surrounding the electronic device, and a control unit which controls to search whether an object pre-stored in the storage unit is in a snapshot image photographed by the photographing unit and to store the search result in the storage unit.

The search result may be location information of the object and a time stamp of a snapshot image including the object.

The control unit may search whether at least one object stored in the storage unit is in a snapshot image photographed by the photographing unit at predetermined intervals and store the search result.

The electronic device may further include a communication unit which communicates with an external electronic device and external database, and the control unit may control to transmit the search result to the external electronic device and the external database.

The communication unit may communicate via a wireless communication link.

The storage unit may store information regarding a location of the electronic device.

The information regarding the object may be information regarding images of the object which are photographed from various distances and various directions.

The electronic device may further include an output unit which outputs the search result.

The control unit may generate a voice command or a user interface (UI) for informing a photographing distance and a photographing direction of the object when storing information regarding the object.

According to an aspect of another exemplary embodiment, there is provided a method for searching for an object around an electronic device, the method including storing information regarding the object, photographing a predetermined area surrounding the electronic device, and searching whether an object pre-stored in the storage unit is in a snapshot image photographed by the photographing unit and storing the search result in the storage unit.

The search result may be location information of the object and a time stamp of a snapshot image including the object.

The storing may include searching whether at least one object stored in the storage unit is in a snapshot image photographed by the photographing unit at predetermined intervals and storing the search result.

The method may further include transmitting the search result to the external electronic device and the external database.

The transmitting may include transmitting the search result using a wireless communication link.

The method may further include storing information regarding a location of the electronic device.

The information regarding the object may be information regarding images of the object which are photographed from various distances and various directions.

The method may further include outputting the search result.

The storing of the information regarding the object may include generating a voice command or a UI for informing a photographing distance and a photographing direction of the object.

According to an aspect of another exemplary embodiment, there is provided an electronic device for searching for an object in a predetermined space around the electronic device, the electronic device including: a storage unit which stores information regarding the object; a photographing unit which photographs at least one image of the predetermined space around the electronic device; and a control unit which controls to search the at least one image photographed by the photographing unit for the object for which information is stored in the storage unit, in and to store a search result in the storage unit.

The search result may include location information of the object and a time stamp of a snapshot image including the object.

The control unit may search for the object in the at least one image at predetermined intervals.

The electronic device may further include: a communication unit which communicates with an external electronic device and an external database, wherein the control unit further controls to transmit the search result to the external electronic device and the external database.

The communication unit may communication via a wireless communication link.

The storage unit may store information regarding a location of the electronic device.

The information regarding the object may include information regarding images of the object which are photographed from a plurality of distances and a plurality of directions.

The electronic device may further include: an output unit which outputs the search result.

The control unit may generate one of a voice message and a user interface which provides a photographing distance and a photographing direction of the object when storing the information regarding the object.

According to an aspect of another exemplary embodiment, there is provided a method for controlling an electronic device for searching for an object around the electronic device, the method including: storing information regarding the object; photographing a predetermined space around the electronic device; and searching whether an object pre-stored in the storage unit is in a snapshot image photographed by the photographing unit and storing search result in the storage unit.

The search result may be location information of the object and a time stamp of a snapshot image including the object.

The storing may include searching whether at least one object stored in the storage unit is in a snapshot image photographed by the photographing unit at predetermined intervals and storing the search result.

The method may further include: transmitting the search result to the external electronic device and the external database.

The transmitting may include transmitting the search result via a wireless communication link.

The method may further include: storing information regarding a location of the electronic device.

The information regarding the object may include information regarding images of the object which are photographed from a plurality of distances and a plurality of directions.

The method may further include: outputting the search result.

The storing of the information regarding the object may include generating one of a voice message and a user interface which provides a photographing distance and a photographing direction of the object.

According to an aspect of another exemplary embodiment, there is provided a digital television which searches for an object within a predetermined space, the digital television including: a camera configured to photograph an image of the predetermined space; a database configured to store information about an object; a user input unit which receives a command from a user; a control unit, wherein if the command is received from the user, the control unit is configured to search the photographed image for the object for which the information is stored in the database, and to generate an indication of a position of the object within the predetermined space based on a result of the search of the photographed image.

The digital television may further include a communication unit which is configured to communicate with an external device, wherein the control unit is further configured to transmit the search result to the external device.

### BRIEF DESCRIPTION OF THE DRAWINGS

The above and/or other aspects will be more apparent by describing certain exemplary embodiments with reference to the accompanying drawings, in which:

FIG. 1 is a view illustrating an electronic device and an object around the electronic object according to an exemplary embodiment;

FIG. 2 is a block diagram illustrating a structure of an electronic device according to an exemplary embodiment; and

FIG. 3 is a flowchart to explain a method for searching for an object in an electronic device according to an exemplary embodiment.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

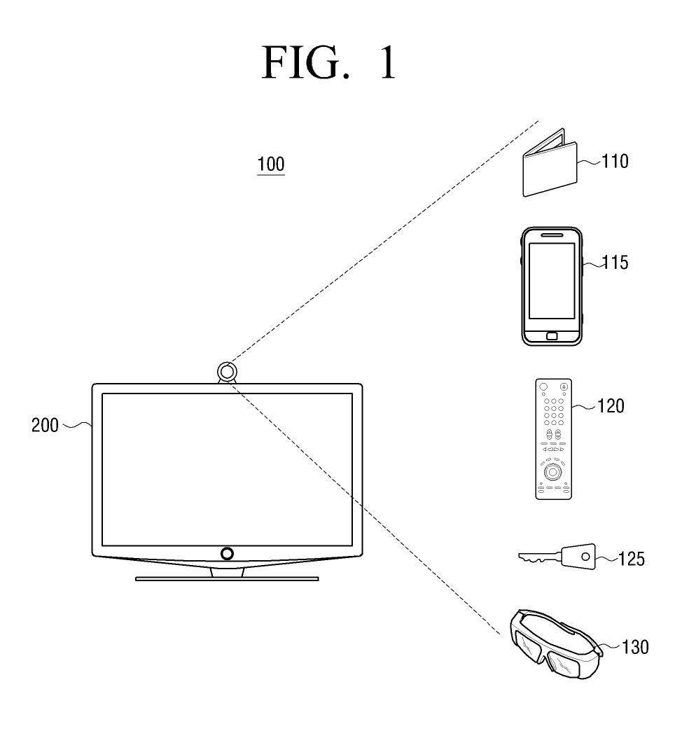

FIG. 1 is a view illustrating a system 100 which tracks an object by an electronic device 200 such as a digital television. As illustrated in FIG. 1, the system 100 includes an electronic device 200, e.g., a digital television (TV) 200, and objects such as a wallet or purse 110, a mobile phone 115, a remote controller 120, a key 125, and glasses 130.

The system 100 according to an exemplary embodiment provides a digital television as the electronic device 200 with a smart search function.

Herein, the smart search function utilizes a pattern recognition algorithm (not shown) for recognizing and storing detailed information of an object registered in a database for the smart search function. The database stores images of an object which is photographed from various directions and distances by the electronic device 200 having a camera. The images may be snapshot images, for example. If the smart search function is provided, an electronic device having a camera photographs images around the electronic device at predetermined time intervals as snapshot images. Subsequently, detailed information of an object in the captured snapshot images are extracted from a smart search database. The snapshot images are scanned to confirm whether they are consistent with an object pre-stored in the database and to check the location. While the snapshot images are scanned, an object is identified in the snapshot images. The detailed information of an object in the snapshot images is recorded in the database to update the current location of the object.

In order to confirm the location of an object, a user provides detailed information of an object to be searched to the electronic device 200 having a smart search function. Subsequently, the smart search database provides a user with the location of the object along with a time stamp of the snapshot image where the object to be searched is included.

According to an exemplary embodiment, the digital TV 200 is installed at a specific location. The digital TV 200 photographs a snapshot image at a current location and registers the current location. An object is placed in front of a camera of the digital TV 200 and snapshot images of the object are photographed from various angles and distances. Accordingly, an object to be tracked by the digital TV 200 is registered in the digital TV 200, and the snapshots are stored in the database. According to the above exemplary embodiment, an object can be recognized whenever the digital TV 200 photographs the object.

According to an exemplary embodiment, the system 100 includes objects that a user commonly wishes to look for in daily life, such as the purse 110, the mobile phone 115, the remote controller 120, the key 125, and the glasses 130.

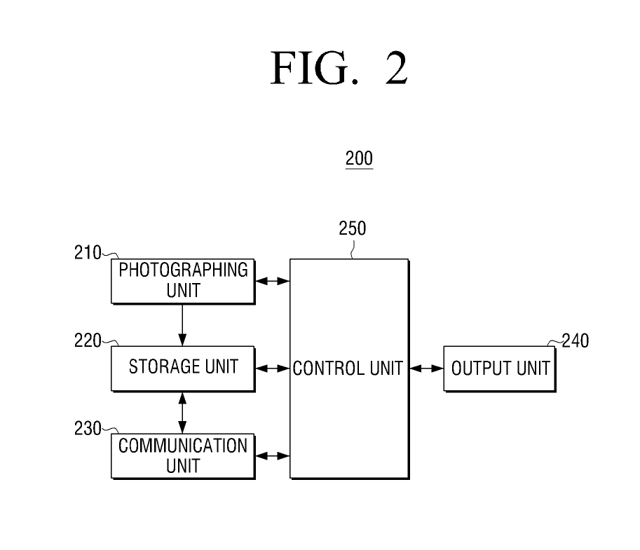

FIG. 2 is a block diagram illustrating the electronic device 100 according to an exemplary embodiment. As illustrated in FIG. 2, the electronic device 200 includes a photographing unit 210, a storage unit 220, a communication unit 230, an output unit 240, and a control unit 250. The term “unit” as used herein means a hardware component, such as a processor or circuit, and/or a software component that is executed by a hardware component such as a processor.

The photographing unit 210 photographs images around the electronic device 100 to a predetermined extent. Specifically, the photographing unit 210 is mounted on the electronic device 100 and may photograph images within a certain extent from a location where the electronic device 100 is installed. Herein, the photographing unit 210 may be realized as a camera.

If the electronic device 200 is an electronic device which is hardly movable such as a digital TV, the photographing unit 210 may photograph images within a fixed space. However, if the electronic device 200 is a mobile device such as a mobile phone or a laptop computer, the photographing unit 220 may photograph images in the area within which the electronic device 200 is moved as opposed to the case where images are photographed within a fixed space.

The storage unit 220 stores various data and programs required to drive the electronic device 200. In particular, the storage unit 220 stores location information of the electronic device 200 and detailed information of an object to provide a smart search function. In this case, the location information of the electronic device 200 may be stored once when the electronic device 200 is installed for the first time. However, if the electronic device 200 is a mobile device such as a mobile phone or a laptop computer, the location information of the electronic device 200 may be renewed whenever a smart search function is performed and stored. In addition, the detailed information of an object may be information regarding the name, size, and shape of an object. In this case, the information regarding the size and shape of an object from among the detailed information of an object may be obtained by photographing the object from various distances and directions.

In addition, the storage unit 220 stores location information of an object which is stored at predetermined intervals under the control of the control unit 250.

The communication unit 230 communicates with an external electronic device, for example, using a wireless communication link such a Wireless Fidelity (Wi-Fi) link. In particular, the communication unit 230 transmits/receives location information of electronic devices, detailed information of an object, and location information of an object to/from an external electronic device to perform a smart search function using a plurality of electronic devices.

The output unit 240 outputs information regarding a searched for object using a smart search function. Specifically, if an object stored in database is included in a photographed snapshot image, the output unit 240 may output the location information of the object to a user.

In this case, the output unit 240 may be realized as a display panel which outputs the location information of the object as visual information or as speaker which outputs the location information of the object as audio information.

The control unit 250 controls the overall operation of the electronic device 200 according to a user command input through a user input unit (not shown). In particular, the control unit 250 may perform the original function of the electronic device 200 according to a user's command. For example, if the electronic device is a television, the control unit 250 may perform a broadcast receiving function according to a user command. In addition, if the electronic device 200 is a mobile phone, the control unit 250 may perform a communication according to a user command.

Further, the control unit 250 provides a smart search function searching for an object around the electronic device 200. As used herein, the term “around” means near, within a vicinity of, or within a predetermined distance of the electronic device 200. Additionally, the term “around” may include a surrounding space, or some portion of a surrounding space.

Specifically, the control unit 250 searches whether an object pre-stored in the storage unit 220 is in a snapshot image photographed by the photographing unit 210 and controls the storage unit 220 so as to store the search result.

That is, the control unit 250 searches whether an object is in a currently photographed snapshot image. If the object is present, the location information of the object is stored in the storage unit 220.

In this case, the control unit 250 may search whether an object pre-stored in the storage unit 220 is in a currently photographed snapshot image at predetermined time intervals. The predetermined intervals may be set by a user or may be set as default at the time of manufacturing.

In addition, the control unit 250 may store the time stamp of a current snapshot image along with the location information of an object. Accordingly, the electronic device 200 may inform a user of not only the location information of an object but also the time information of the object.

Meanwhile, when the detailed information of an object is registered, the control unit 250 may generate an indication such as a voice message or a UI so as to photograph the object from various distances and various directions.

In addition, the control unit 250 may control the communication unit 230 to transmit a search result of an object to an external device at predetermined time intervals. Accordingly, as the electronic device 200 is synchronized with an external electronic device, the electronic device 200 may provide a smart search function through a plurality of electronic devices.

Further, the control unit 250 may output a search result of a searched for object through the output unit 240. In this case, the control unit 250 may output location information of an object as visual information or audible information through the output unit 240. For example, if a purse 110 is searched for in a snapshot image photographed at 2:30 P.M., the control unit 250 may output information that the purse has been searched for at 2:30 P.M., as visual information or audible information through the output unit 240.

By using the electronic device 200 as described above, information regarding location and time where an object was found right before it had been lost is provided to a user and thus, a user may find the object more easily as a search range of the object can be narrowed.

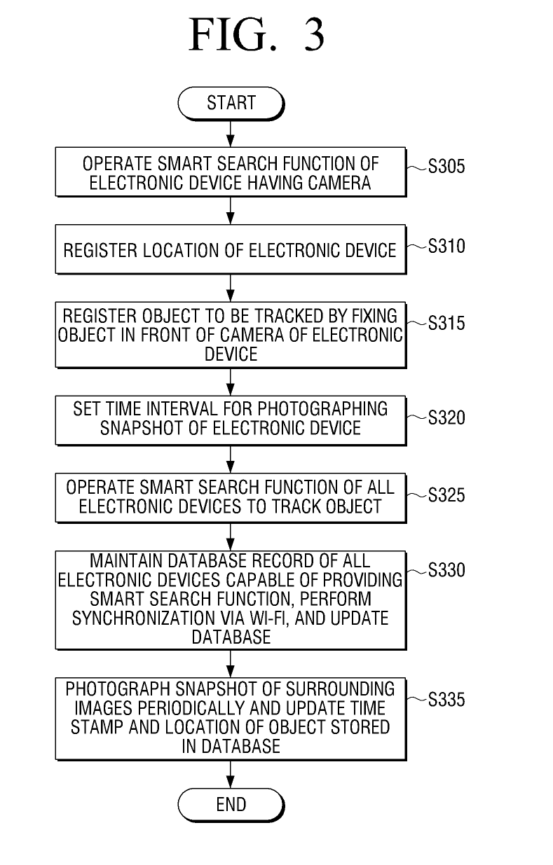

FIG. 3 is a flowchart to explain a smart search function for tracking an object according to an exemplary embodiment.

A user operates a smart search function in operation S305.

In operation S310, an electronic device having a camera registers a location where the electronic device is installed. For example, if a digital TV is installed in a living room, the electronic device registers the location of the living room where the electronic device is installed. However, a user may register every location within a specific range such as a house or a workplace for mobile electronic devices such as a laptop computer or a mobile phone. The above registration may be performed once, such as at an initial stage.

In operation S315, a user registers an object to be searched using a smart search function by fixing the object in front of a digital TV, mobile phone, camera of a laptop computer, camera of an electronic device, etc., which has a smart search function.

The smart search function guides a user to register an object using a guide such as an audio command or an online text message regarding direction and distance of the object to be registered. In this case, the guide may include close-up photography, short range photography, and/or long range photography so as to enable a pattern recognition algorithm to recognize an object.

In operation S320, a user sets time intervals for photographing snapshot images around an electronic device.

In operation S325, a user operates a smart search function of every electronic device at home and workplace to track an object of interest.

In operation S330, copy of database is maintained in every available device. In other words, the database synchronizes devices connected with each other via a communication link, for example, a wireless communication link such as a Wi-Fi link, and thus, every electronic device may share the database.

In operation S335, an electronic device starts photographing snapshots around the electronic device periodically. In the first snapshot image, the electronic device checks and records a location. In all of the subsequent snapshots, a smart search function of the electronic device searches the database to check whether a photographed object is recorded in the database. If an object or objects is/are found, the detailed information of the object(s) found in a snapshot image is recorded in the database along with a time stamp to update the current location of the object.

Lastly, a user checks the smart search database and every electronic device which is synchronized with other electronic devices. The database updates location information from every electronic device having the smart search function. To confirm the location of an object, a user may provide detailed information of a searched for object. Subsequently, the smart search database provides the user with a location of the object along with a time stamp of a snapshot image of the object for which the user searches. Therefore, the user may be provided with the information regarding location and time where the object was found right before it had been lost. Accordingly, the user may find an object more easily as a search range of the object can be narrowed.

Although a few exemplary embodiments have been shown and described, it would be appreciated by those skilled in the art that changes may be made in these exemplary embodiments without departing from the principles and spirit of the present inventive concept.

What is claimed is:

1. An electronic device for searching for an object in a predetermined space around the electronic device, the electronic device comprising:
a storage unit which stores information regarding the object;
a photographing unit which photographs at least one image of the predetermined space around the electronic device; and
a control unit which searches the at least one image photographed by the photographing unit for the object for which information is stored in the storage unit, in and stores a search result in the storage unit.

2. The electronic device as claimed in claim 1, wherein the search result comprises location information of the object and a time stamp of a snapshot image including the object.

3. The electronic device as claimed in claim 1, wherein the control unit searches for the object in the at least one image at predetermined intervals.

4. The electronic device as claimed in claim 1, further comprising:
a communication unit which communicates with an external electronic device and an external database,
wherein the control unit controls the communication unit to transmit the search result to the external electronic device and the external database.

5. The electronic device as claimed in claim 4, wherein the communication unit communicates via a wireless communication link.

6. The electronic device as claimed in claim 1, wherein the storage unit stores information regarding a location of the electronic device.

7. The electronic device as claimed in claim 1, wherein the information regarding the object comprises information regarding images of the object which are photographed from a plurality of distances and a plurality of directions.

8. The electronic device as claimed in claim 1, further comprising: an output unit which outputs the search result.

9. The electronic device as claimed in claim 1, wherein the control unit generates one of a voice message and a user interface which provides a photographing distance and a photographing direction of the object when storing the information regarding the object.

10. A method for controlling an electronic device for searching for an object around the electronic device, the method comprising:
storing information regarding the object;
photographing a predetermined space around the electronic device; and
searching whether an object pre-stored in the storage unit is in a snapshot image photographed by the photographing unit and storing search result in the storage unit.

11. The method as claimed in claim 10, wherein the search result is location information of the object and a time stamp of a snapshot image including the object.

12. The method as claimed in claim 10, wherein the storing comprises searching whether at least one object stored in the storage unit is in a snapshot image photographed by the photographing unit at predetermined intervals and storing the search result.

13. The method as claimed in claim 10, further comprising: transmitting the search result to the external electronic device and the external database.

14. The method as claimed in claim 13, wherein the transmitting comprises transmitting the search result via a wireless communication link.

15. The method as claimed in claim 10, further comprising: storing information regarding a location of the electronic device.

16. The method as claimed in claim 10, wherein the information regarding the object comprises information regarding images of the object which are photographed from a plurality of distances and a plurality of directions.

17. The method as claimed in claim 10, further comprising: outputting the search result.

18. The method as claimed in claim 10, wherein the storing of the information regarding the object comprises generating one of a voice message and a user interface which provides a photographing distance and a photographing direction of the object.

19. A digital television which searches for an object within a predetermined space, the digital television comprising:
a camera configured to photograph an image of the predetermined space;
a database configured to store information about an object;
a user input unit which receives a command from a user;
a control unit, wherein if the command is received from the user, the control unit is configured to search the photographed image for the object for which the information is stored in the database, and to generate an indication of a position of the object within the predetermined space based on a result of the search of the photographed image.

20. The digital television as claimed in claim 19, further comprises a communication unit which is configured to communicate with an external device, wherein the control unit is further configured to transmit the search result to the external device.
